(19) United States
(12) Patent Application Publication
(10) Pub. No.: US 2022/0174890 A1
(43) Pub. Date: Jun. 9, 2022

(54) METHOD OF OPERATING A LIGHTING SYSTEM FOR AN INDOOR GARDEN CENTER

(71) Applicant: Haier US Appliance Solutions, Inc., Wilmington, DE (US)

(72) Inventors: Louis A. Wantland, Louisville, KY (US); Jordan Andrew Waymeyer, Louisville, KY (US)

(21) Appl. No.: 17/111,579

(22) Filed: Dec. 4, 2020

(51) Int. Cl. A01G 9/24; A01G 7/04; F21V 23/00; F21V 29/60

(52) U.S. Cl. CPC A01G 9/249; A01G 9/246; F21Y 2115/10; F21V 23/003; F21V 29/60; A01G 7/045

(57) ABSTRACT

An indoor gardening appliance includes a liner defining a grow chamber and a grow module rotatably mounted within the grow chamber to divide the grow chamber into a plurality of grow chambers. A lighting system includes a first lighting assembly positioned within the liner adjacent a first grow chamber and a second lighting assembly positioned within the liner adjacent a second grow chamber. Each of these lighting assemblies may include different types of grow lighting, ultraviolet lighting, or other light sources that may be independently controlled to generate light in different colors, wavelengths, and intensities as needed to facilitate improved plant growth.

### FIELD OF THE INVENTION

The present subject matter relates generally to systems for gardening plants indoors, and more particularly, to a lighting system and method for operating the lighting system for improved plant growth in an indoor gardening appliance.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature or humidity. Certain indoor garden centers may also include hydration systems for watering the plants and/or artificial lighting systems that provide the light necessary for such plants to grow.

However, conventional artificial lighting systems include only a single lighting array that emits constant light at a fixed wavelength and intensity. These lighting systems are rigid in their operation and provided little versatility for adjusting the lighting available in a grow environment. Notably, certain plants may benefit from specific lighting conditions, varying lighting conditions, and light emitted at wavelengths that cannot be generated with conventional lighting systems. For example, certain plants may benefit from being exposed to ultraviolet light (in both the A and B spectrums), which may result in healthier or more robust plants.

Accordingly, an improved indoor garden center would be useful. More particularly, an indoor garden center with a lighting system that is capable of providing versatile lighting conditions would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a gardening appliance is provided including a liner positioned within a cabinet and defining a grow chamber, a grow module rotatably mounted within the liner, the grow module dividing the grow chamber into a plurality of grow chambers, a first lighting assembly positioned within the liner adjacent a first grow chamber of the plurality of grow chambers, a second lighting assembly positioned within the liner adjacent a second grow chamber of the plurality of grow chambers, and a controller operably coupled to the first lighting assembly and the second lighting assembly, the controller being configured to operate each of the first lighting assembly and the second lighting assembly independently based on needs of plants located within the first grow chamber and the second grow chamber.

In another exemplary embodiment, a lighting system for a gardening appliance is provided. The gardening appliance includes a liner positioned defining a grow chamber and a grow module rotatably mounted within the liner and dividing the grow chamber into a first grow chamber and a second grow chamber. The lighting system includes a first lighting assembly positioned within the liner adjacent the first grow chamber, a second lighting assembly positioned within the liner adjacent the second grow chamber, and a controller operably coupled to the first lighting assembly and the second lighting assembly, the controller being configured to operate each of the first lighting assembly and the second lighting assembly independently based on needs of plants located within the first grow chamber and the second grow chamber.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gardening appliance according to an exemplary embodiment of the present subject matter.

FIG. 2 depicts a front view of the exemplary gardening appliance of FIG. 1 with the doors open according to an exemplary embodiment of the present subject matter.

FIG. 3 is a cross sectional view of the exemplary gardening appliance of FIG. 1, taken along Line 3-3 from FIG. 2 with an internal divider removed for clarity.

FIG. 4 is a top perspective view of the exemplary gardening appliance of FIG. 1, with the top panel of the cabinet removed to reveal a rotatable grow module according to an exemplary embodiment of the present subject matter.

FIG. 5 provides a perspective cross sectional view of the exemplary gardening appliance of FIG. 1 according to another exemplary embodiment of the present subject matter.

FIG. 6 provides a perspective view of the grow module of the exemplary gardening appliance of FIG. 1 according to another exemplary embodiment of the present subject matter.

FIG. 7 provides a perspective cross sectional view of the exemplary grow module of FIG. 6 according to another exemplary embodiment of the present subject matter.

FIG. 8 provides a top cross-sectional view of the exemplary grow module of FIG. 6 according to another exemplary embodiment of the present subject matter.

FIG. 9 is a top view of the exemplary gardening appliance of FIG. 1, with a lighting system illustrated schematically according to an exemplary embodiment of the present subject matter.

FIG. 10 provides an exploded perspective view of a lighting board of the exemplary lighting system of FIG. 9 according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “approximately,” “substantially,” or “about,” refer to being within a ten percent (10%) margin of error of the stated value. Moreover, as used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

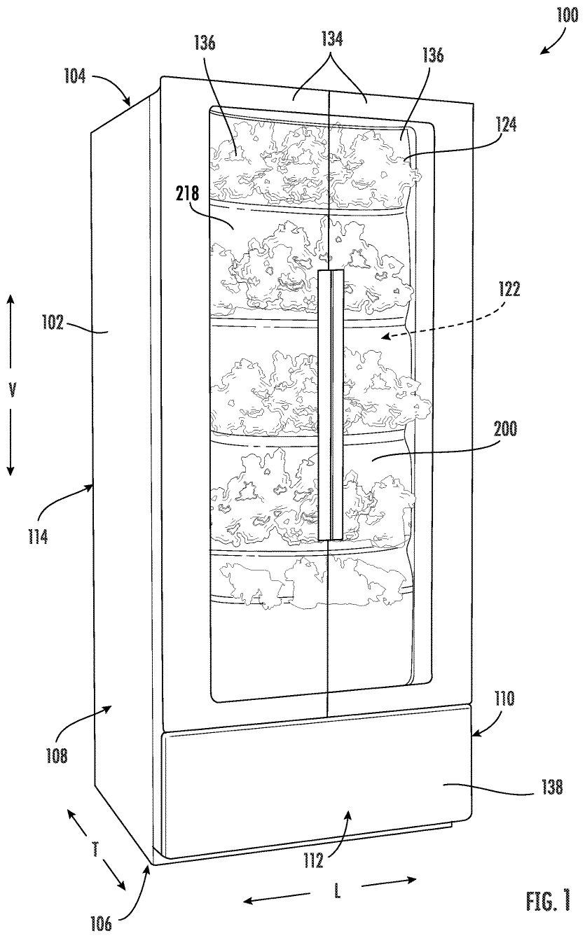

FIG. 1 provides a front view of a gardening appliance 100 according to an exemplary embodiment of the present subject matter. According to exemplary embodiments, gardening appliance 100 may be used as an indoor garden center for growing plants. It should be appreciated that the embodiments described herein are intended only for explaining aspects of the present subject matter. Variations and modifications may be made to gardening appliance 100 while remaining within the scope of the present subject matter.

Gardening appliance 100 includes a housing or cabinet 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another and form an orthogonal direction system.

Gardening appliance 100 may include an insulated liner 120 positioned within cabinet 102. Liner 120 may at least partially define a temperature controlled, referred to herein generally as a grow chamber 122, within which plants 124 may be grown. Although gardening appliance 100 is referred to herein as growing plants 124, it should be appreciated that other organisms or living things may be grown or stored in gardening appliance 100. For example, algae, fungi (e.g., including mushrooms), or other living organisms may be grown or stored in gardening appliance 100. The specific application described herein is not intended to limit the scope of the present subject matter.

Cabinet 102, or more specifically, liner 120 may define a substantially enclosed back region or portion 130. In addition, cabinet 102 and liner 120 may define a front opening, referred to herein as front display opening 132, through which a user of gardening appliance 100 may access grow chamber 122, e.g., for harvesting, planting, pruning, or otherwise interacting with plants 124. According to an exemplary embodiment, enclosed back portion 130 may be defined as a portion of liner 120 that defines grow chamber 122 proximate rear side 114 of cabinet 102. In addition, front display opening 132 may generally be positioned proximate or coincide with front side 112 of cabinet 102.

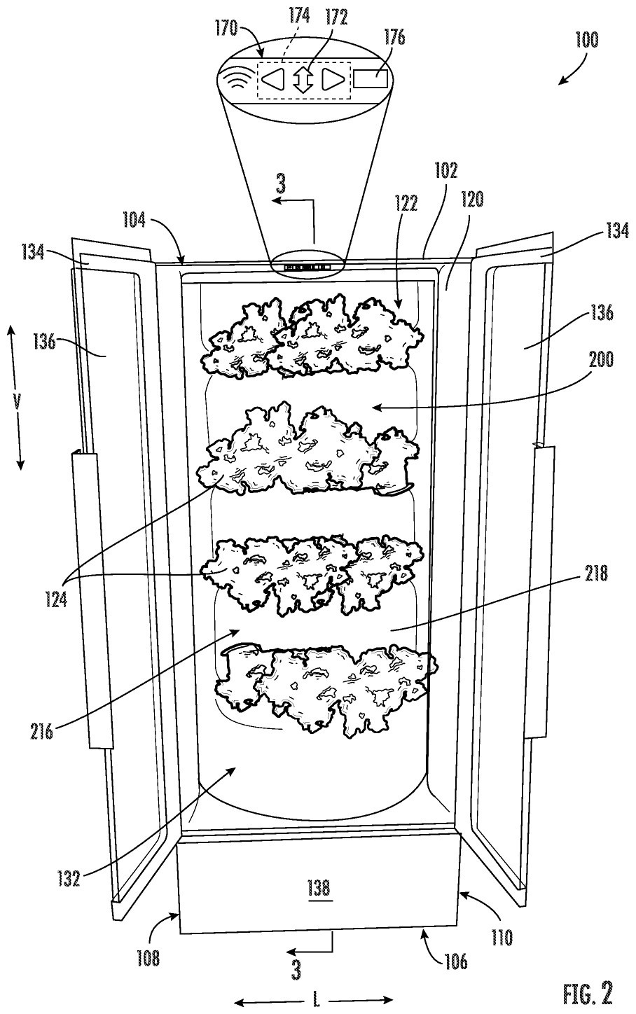

Gardening appliance 100 may further include one or more doors 134 that are rotatably mounted to cabinet 102 for providing selective access to grow chamber 122. For example, FIG. 1 illustrates doors 134 in the closed position such that they may help insulate grow chamber 122. By contrast, FIG. 2 illustrates doors 134 in the open positioned for accessing grow chamber 122 and plants 124 stored therein. Doors 134 may further include a transparent window 136 through which a user may observe plants 124 without opening doors 134.

Although doors 134 are illustrated as being rectangular and being mounted on front side 112 of cabinet 102 in FIGS. 1 and 2, it should be appreciated that according to alternative embodiments, doors 134 may have different shapes, mounting locations, etc. For example, doors 134 may be curved, may be formed entirely from glass, etc. In addition, doors 134 may have integral features for controlling light passing into and/or out of grow chamber 122, such as internal louvers, tinting, UV treatments, polarization, etc. One skilled in the art will appreciate that other chamber and door configurations are possible and within the scope of the present invention.

According to the illustrated embodiment, cabinet 102 further defines a drawer 138 positioned proximate bottom 106 of cabinet 102 and being slidably mounted to cabinet for providing convenient storage for plant nutrients, system accessories, water filters, etc. In addition, behind drawer 138 is a mechanical compartment 140 for receipt of an environmental control system including a sealed system for regulating the temperature within grow chamber 122, as described in more detail below.

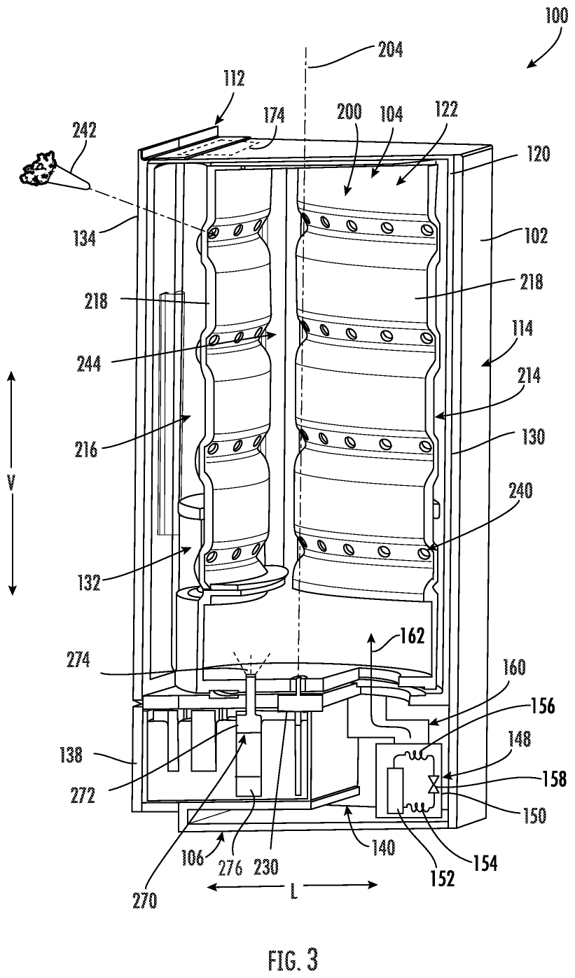

FIG. 3 provides a schematic view of certain components of an environmental control system 148 that may be used to regulate a temperature within grow chamber 122. Specifically, environmental control system 148 may include a sealed system 150, a duct system 160, and a hydration system 270, a lighting system 300, or any other suitable components or subsystems for regulating an environment within grow chamber 122, e.g., for facilitating improved or regulated growth of plants 124 positioned therein. Specifically, FIG. 3 illustrates sealed system 150 within mechanical compartment 140. Although an exemplary sealed system is illustrated and described herein, it should be appreciated that variations and modifications may be made to sealed system 150 while remaining within the scope of the present subject matter. For example, sealed system 150 may include additional or alternative components, different ducting configurations, etc.

As shown, sealed system 150 includes a compressor 152, a first heat exchanger or evaporator 154 and a second heat exchanger or condenser 156. As is generally understood, compressor 152 is generally operable to circulate or urge a flow of refrigerant through sealed system 150, which may include various conduits which may be utilized to flow refrigerant between the various components of sealed system 150. Thus, evaporator 154 and condenser 156 may be between and in fluid communication with each other and compressor 152.

During operation of sealed system 150, refrigerant flows from evaporator 154 and to compressor 152, and compressor 152 is generally configured to direct compressed refrigerant from compressor 152 to condenser 156. For example, refrigerant may exit evaporator 154 as a fluid in the form of a superheated vapor. Upon exiting evaporator 154, the refrigerant may enter compressor 152, which is operable to compress the refrigerant. Accordingly, the pressure and temperature of the refrigerant may be increased in compressor 152 such that the refrigerant becomes a more superheated vapor.

Condenser 156 is disposed downstream of compressor 152 and is operable to reject heat from the refrigerant. For example, the superheated vapor from compressor 152 may enter condenser 156 and transfer energy to air surrounding condenser 156 (e.g., to create a flow of heated air). In this manner, the refrigerant condenses into a saturated liquid and/or liquid vapor mixture. A condenser fan (not shown) may be positioned adjacent condenser 156 and may facilitate or urge the flow of heated air across the coils of condenser 156 (e.g., from ambient atmosphere) in order to facilitate heat transfer.

According to the illustrated embodiment, an expansion device or a variable electronic expansion valve 158 may be further provided to regulate refrigerant expansion. During use, variable electronic expansion valve 158 may generally expand the refrigerant, lowering the pressure and temperature thereof. In this regard, refrigerant may exit condenser 156 in the form of high liquid quality/saturated liquid vapor mixture and travel through variable electronic expansion valve 158 before flowing through evaporator 154. Variable electronic expansion valve 158 is generally configured to be adjustable, e.g., such that the flow of refrigerant (e.g., volumetric flow rate in milliliters per second) through variable electronic expansion valve 158 may be selectively varied or adjusted.

Evaporator 154 is disposed downstream of variable electronic expansion valve 158 and is operable to heat refrigerant within evaporator 154, e.g., by absorbing thermal energy from air surrounding the evaporator (e.g., to create a flow of cooled air). For example, the liquid or liquid vapor mixture refrigerant from variable electronic expansion valve 158 may enter evaporator 154. Within evaporator 154, the refrigerant from variable electronic expansion valve 158 receives energy from the flow of cooled air and vaporizes into superheated vapor and/or high quality vapor mixture. An air handler or evaporator fan (not shown) is positioned adjacent evaporator 154 and may facilitate or urge the flow of cooled air across evaporator 154 in order to facilitate heat transfer. From evaporator 154, refrigerant may return to compressor 152 and the vapor-compression cycle may continue.

As explained above, environmental control system 148 includes a sealed system 150 for providing a flow of heated air or a flow cooled air throughout grow chamber 122 as needed. To direct this air, environmental control system 148 includes a duct system 160 for directing the flow of temperature regulated air, identified herein simply as flow of air 162 (see, e.g., FIG. 3). In this regard, for example, an evaporator fan can generate a flow of cooled air as the air passes over evaporator 154 and a condenser fan can generate a flow of heated air as the air passes over condenser 156.

These flows of air 162 are routed through a cooled air supply duct and/or a heated air supply duct (not shown), respectively. In this regard, it should be appreciated that environmental control system 148 may generally include a plurality of ducts, dampers, diverter assemblies, and/or air handlers to facilitate operation in a cooling mode, in a heating mode, in both a heating and cooling mode, or any other mode suitable for regulating the environment within grow chamber 122. It should be appreciated that duct system 160 may vary in complexity and may regulate the flows of air from sealed system 150 in any suitable arrangement through any suitable portion of grow chamber 122.

Gardening appliance 100 may include a control panel 170. Control panel 170 includes one or more input selectors 172, such as e.g., knobs, buttons, push buttons, touchscreen interfaces, etc. In addition, input selectors 172 may be used to specify or set various settings of gardening appliance 100, such as e.g., settings associated with operation of sealed system 150. Input selectors 172 may be in communication with a processing device or controller 174. Control signals generated in or by controller 174 operate gardening appliance 100 in response to input selectors 172. Additionally, control panel 170 may include a display 176, such as an indicator light or a screen. Display 176 is communicatively coupled with controller 174 and may display information in response to signals from controller 174. Further, as will be described herein, controller 174 may be communicatively coupled with other components of gardening appliance 100, such as e.g., one or more sensors, motors, or other components.

As used herein, “processing device” or “controller” may refer to one or more microprocessors or semiconductor devices and is not restricted necessarily to a single element. The processing device can be programmed to operate gardening appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

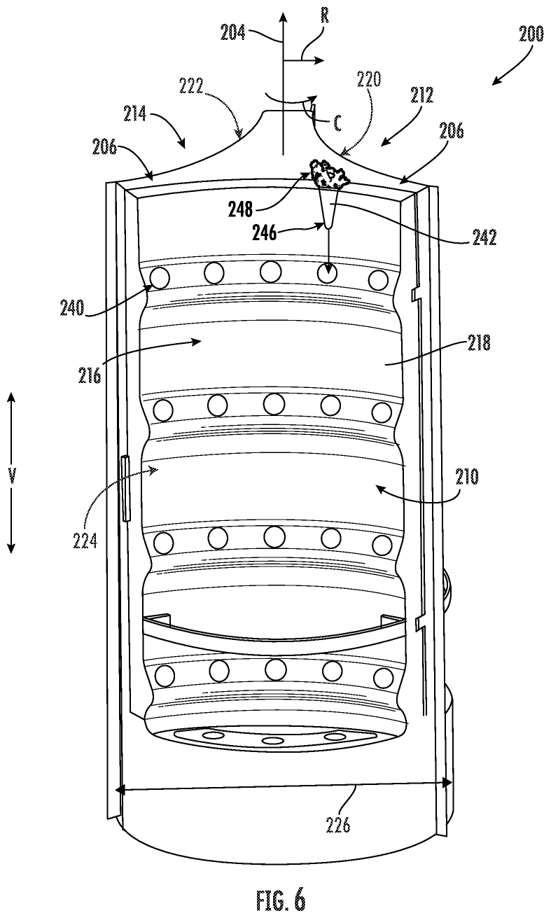

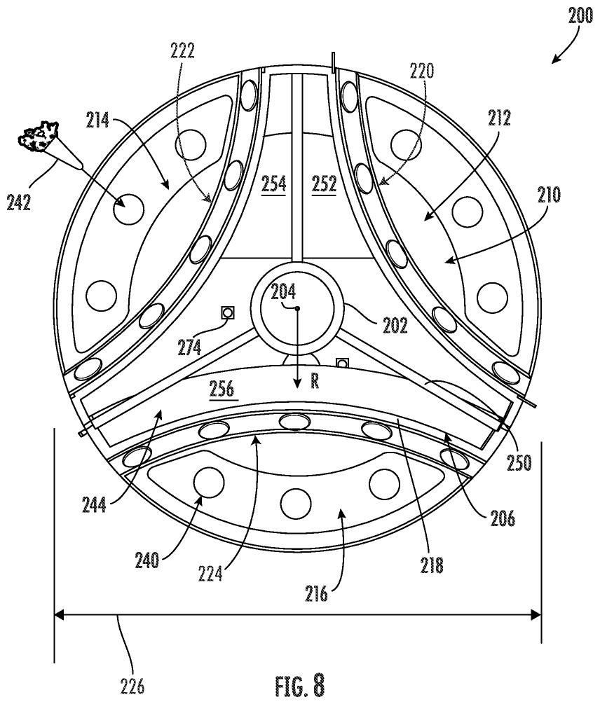

Referring now generally to FIGS. 1 through 8, gardening appliance 100 generally includes a rotatable carousel, referred to herein as a grow module 200 that is mounted within liner 120, e.g., such that it is rotatable within grow chamber 122. As illustrated, grow module 200 includes a central hub 202 that extends along and is rotatable about a central axis 204. Specifically, according to the illustrated embodiment, central axis 204 is parallel to the vertical direction V. However, it should be appreciated that central axis 204 could alternatively extend in any suitable direction, e.g., such as the horizontal direction. In this regard, grow module 200 generally defines an axial direction, i.e., parallel to central axis 204, a radial direction R that extends perpendicular to central axis 204, and a circumferential direction C that extends around central axis 204 (e.g. in a plane perpendicular to central axis 204).

Grow module 200 may further include a plurality of partitions 206 that extend from central hub 202 substantially along the radial direction R. In this manner, grow module 200 divides or partitions grow chamber 122 into a plurality of sub-compartments or sub-chambers, referred to herein generally by reference numeral 210, when it is in its zero position as illustrated. Referring specifically to a first embodiment of grow module 200 illustrated in FIGS. 1 through 8, grow module 200 includes three partitions 206 to divide grow chamber 122 into a first grow chamber 212, a second grow chamber 214, and a third grow chamber 216, which are circumferentially spaced relative to each other. For example, each grow chambers 212-216 may each span approximately 120° about the circumferential direction C. In general, as grow module 200 is rotated within grow chamber 122, the plurality of chambers 212-216 refer to the fixed regions within grow chamber 122 that define substantially separate and distinct growing environments, e.g., for growing plants 124 having different growth needs.

As shown, grow module 200 defines three different plant support sections, referred to herein as first support section 220, second support section 222, and third support section 224. Notably, as grow module 200 is rotated within liner 120, support sections 220-224 are sequentially positioned or cycled through each respective grow chamber 212-216. In this manner, the environment within each grow chamber 212-216 may be independently regulated in a manner suitable to plants supported within support section 220-224 that is currently positioned therein. More specifically, partitions 206 may extend from central hub 202 to a location immediately adjacent liner 120. Although partitions 206 are described as extending along the radial direction, it should be appreciated that they need not be entirely radially extending. For example, according to the illustrated embodiment, the distal ends of each partition are joined with an adjacent partition using an arcuate wall 218, which is generally used to support plants 124.

Notably, it is desirable according to exemplary embodiments to form a substantial seal between partitions 206 and liner 120. Therefore, according to an exemplary embodiment, grow module 200 may define a grow module diameter 226 (e.g., defined by its substantially circular footprint formed in a horizontal plane). Similarly, enclosed back portion 130 of liner 120 may be substantially cylindrical and may define a liner diameter 228. In order to prevent a significant amount of air from escaping between partitions 206 and liner 120, liner diameter 228 may be substantially equal to or slightly larger than grow module diameter 226. Grow module 200 may further includes one or more resilient sealing elements, such as a wiper seal, to engage liner 120 and form environmental seals for first grow chamber 212 and second grow chamber 214.

Referring now specifically to FIG. 3, gardening appliance 100 may further include a motor 230 or another suitable driving element or device for selectively rotating grow module 200 during operation of gardening appliance 100. In this regard, according to the illustrated embodiment, motor 230 is positioned below grow module 200, e.g., within mechanical compartment 140, and is operably coupled to grow module 200 along central axis 204 for rotating grow module 200.

As used herein, “motor” may refer to any suitable drive motor and/or transmission assembly for rotating grow module 200. For example, motor 230 may be a brushless DC electric motor, a stepper motor, or any other suitable type or configuration of motor. For example, motor 230 may be an AC motor, an induction motor, a permanent magnet synchronous motor, or any other suitable type of AC motor. In addition, motor 230 may include any suitable transmission assemblies, clutch mechanisms, or other components.

According to an exemplary embodiment, motor 230 may be operably coupled to controller 174, which is programmed to rotate grow module 200 according to predetermined operating cycles, based on user inputs (e.g. via touch buttons 172), etc. In addition, controller 174 may be communicatively coupled to one or more sensors, such as temperature or humidity sensors, positioned within the various sub-chambers 210 for measuring temperatures and/or humidity, respectively. Controller 174 may then operate environmental control system 148 to maintain desired environmental conditions for each of the respective sub-chambers 210 and may selectively position support sections 220-224 in the desired sub-chambers 210 to facilitate optimal plant growth. For example, as will be described in more detail below, gardening appliance 100 includes features for providing certain locations of gardening appliance 100 with light, temperature control, proper moisture, nutrients, and other requirements for suitable plant growth. Motor 230 may be used to position specific support sections 220-224 where needed to receive such growth requirements.

According to an exemplary embodiment, such as where three partitions 206 form three grow chambers 212-216, controller 174 may operate motor 230 to index grow module 200 sequentially through a number of preselected positions. More specifically, motor 230 may rotate grow module 200 in a counterclockwise direction (e.g. when viewed from a top of grow module 200) in 120° increments to move support sections 220-224 between sealed positions and display positions. As used herein, a support section 220-224 is considered to be in a “sealed position” when that support section 220-224 is substantially sealed between grow module 200 (i.e., central hub 202 and adjacent partitions 206) and liner 120. In other words, support sections 220-224 are in a sealed position when positioned in the first grow chamber 212 or second grow chamber 214. By contrast, a support section 220-224 is considered to be in a “display position” when that support section 220-224 is at least partially exposed to front display opening 132, such that a user may access plants 124 positioned within that support section 220-224. In other words, support sections 220-224 are in a display position when positioned in the third grow chamber 216.

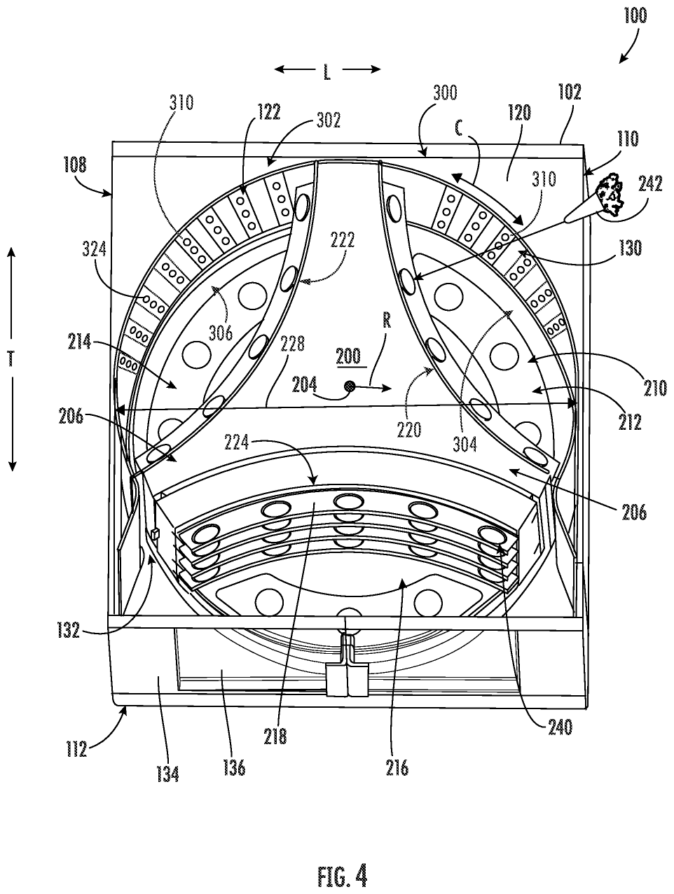

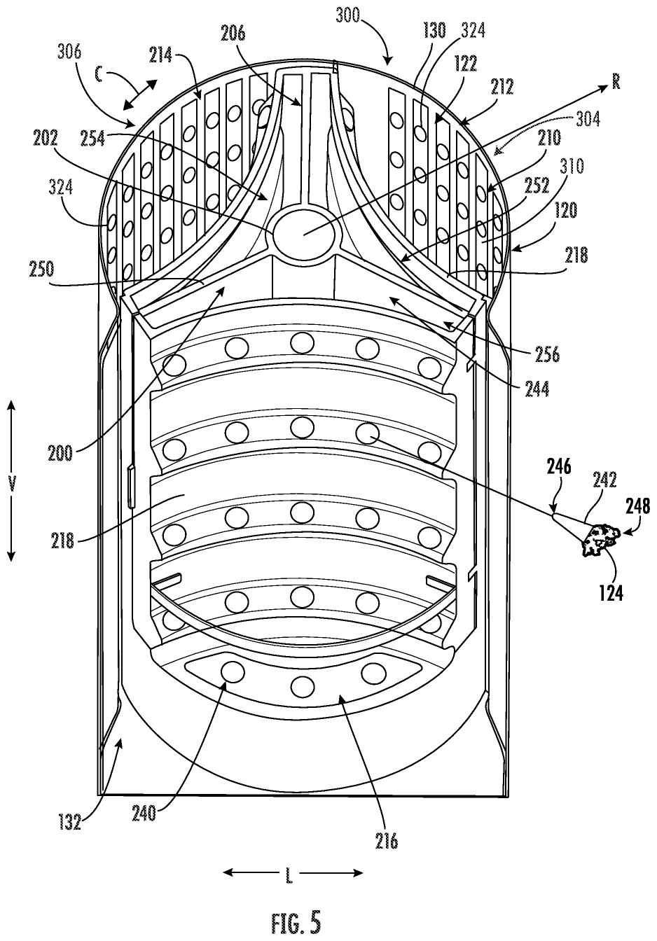

For example, as illustrated in FIGS. 4 and 5, first support section 220 and second support section 222 are both in a sealed position, whereas third support section 224 is in a display position. As motor 230 rotates grow module 200 by 120 degrees in the counterclockwise direction, second support section 222 will enter the display position, while first support section 220 and third support section 224 will be in the sealed positions. Motor 230 may continue to rotate grow module 200 in such increments to cycle grow chambers 210 between these sealed and display positions.

Referring now generally to FIGS. 4 through 8, grow module 200 will be described in more detail according to an exemplary embodiment of the present subject matter. As shown, grow module 200 defines a plurality of apertures 240 which are generally configured for receiving plant pods 242 into an internal root chamber 244. Plant pods 242 generally contain seedlings or other material for growing plants positioned within a mesh or other support structure through which roots of plants 124 may grow within grow module 200. A user may insert a portion of plant pod 242 (e.g., a seed end or root end 246) having the desired seeds through one of the plurality of apertures 240 into root chamber 244. A plant end 248 of the plant pod 242 may remain within grow sub-chambers 210 such that plants 124 may grow from grow module 200 such that they are accessible by a user. In this regard, grow module 200 defines root chamber 244, e.g., within at least one of central hub 202 and the plurality of partitions 206. As will be explained below, water and other nutrients may be supplied to the root end 246 of plant pods 242 within root chamber 244. Notably, apertures 240 may be covered by a flat flapper seal (not shown) to prevent water from escaping root chamber 244 when no plant pod 242 is installed.

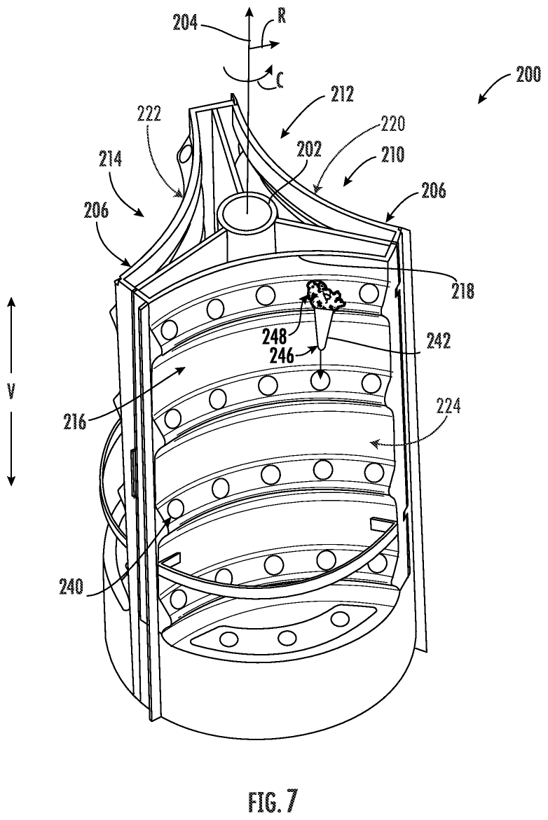

As best shown in FIGS. 5 and 7, grow module 200 may further include an internal divider 250 that is positioned within root chamber 244 to divide root chamber 244 into a plurality of root chambers, each of the plurality of root chambers being in fluid communication with one of the plurality of grow sub-chambers 210 through the plurality of apertures 240. More specifically, according to the illustrated embodiment, internal divider 250 may divide root chamber 244 into a first root chamber 252, a second root chamber 254, and a third root chamber 256. According to an exemplary embodiment, first root chamber 252 may provide water and nutrients to plants 124 positioned in the first support section 220, second root chamber 254 may provide water and nutrients to plants 124 positioned in the second support section 222, and third root chamber 256 may provide water and nutrients to plants 124 positioned in the third support section 224. In this manner, environmental control system 148 may control the temperature and/or humidity of each of the plurality of chambers 212-216 and the plurality of root chambers 252-256 independently of each other.

Environmental control system 148 may further include a hydration system 270 which is generally configured for providing water to plants 124 to support their growth. Specifically, according to the illustrated embodiment, hydration system 270 generally includes a water supply 272 and misting device 274 (e.g., such as a fine mist spray nozzle or nozzles). For example, water supply 272 may be a reservoir containing water (e.g., distilled water) or may be a direct connection municipal water supply. According to exemplary embodiments, hydration system 270 may include one or more pumps 276 (see FIG. 15) for providing a flow of liquid nutrients to misting device 274. In this regard, for example, water or nutrients that are not absorbed by roots of plants 124 may fall under the force of gravity into a sump 278. Pump 276 may be fluidly coupled to sump 278 to recirculate the water through misting device 274.

Misting device 274 may be positioned at a bottom of root chamber 244 and may be configured for charging root chamber 244 with mist for hydrating the roots of plants 124. Alternatively, misting devices 274 may pass through central hub 204 along the vertical direction V and periodically include a nozzle for spraying a mist or water into root chamber 244. Because various plants 124 may require different amounts of water for desired growth, hydration system 270 may alternatively include a plurality of misting devices 274, e.g., all coupled to water supply 272, but being selectively operated to charge each of first root chamber 252, second root chamber 254, and third root chamber 256 independently of each other.

Notably, environmental control system 148 described above is generally configured for regulating the temperature, humidity (e.g., or some other suitable water level quantity or measurement), and other grow parameters within one or all of the plurality of chambers 210 and/or root chambers 252-256 independently of each other. In this manner, a versatile and desirable growing environment may be obtained for each and every chamber 210.

Referring now specifically to FIGS. 4-5 and 9-10, gardening appliance 100 may further include a lighting system 300 which is generally configured for providing light into grow chamber 122 to facilitate photosynthesis and growth of plants 124. Specifically, as described in more detail below, lighting system 300 may include numerous lighting assemblies (identified generally by reference numeral 302) that may generate light having different wavelengths, intensities, colors, etc. Moreover, each lighting assembly 302 may be independently operated, e.g., by controller 174 of gardening appliance 100, in order to provide optimal lighting needs for each plant located within each of the plurality of grow chambers 212-216.

Notably, the lighting assemblies 302 positioned within each grow chamber 212-216 may be different and independently operated for more versatility in the grow lighting or other lighting directed toward plants 124. In this regard, the lighting assembly 302 in first grow chamber 212 may be referred to herein as first lighting assembly 304, while the lighting assembly 302 in second grow chamber 214 may be referred to herein as the second lighting assembly 306. Exemplary configurations of lighting assemblies 304 and 306 will be described below according to exemplary embodiments of the present subject matter. However, it should be appreciated that the specific lighting configurations shown are only intended to explain aspects of the present subject matter. Thus, variations and modifications may be made to lighting assemblies 304, 306 while remaining within the scope of the present subject matter.

According to the illustrated embodiment, the third grow chamber 216 is a and “resting chamber.” In this regard, third grow chamber 216 may not include any grow lighting other than natural lighting that enters through doors 134. Notably, by maintaining all lighting assemblies 302 within first grow chamber 212 and second grow chamber 214, light emitted from lighting assemblies 302 may not escape cabinet through front display opening 132. Specifically, as described below, grow module 200 may substantially block the view of first grow chamber 212 and second grow chamber 214. Notably, as explained herein, this configuration may provide for optimal lighting requirements while minimizing light bleed, light pollution, and other harmful effects of light generated by lighting assemblies 302. Although third grow chamber 216 is illustrated herein is not containing any lighting assembly 302, it should be appreciated that exemplary embodiments of the present subject matter may include certain types of grow lighting within third grow chamber 216.

As explained above, light generated from lighting system 300 may result in light pollution within a room where gardening appliance 100 is located. Therefore, aspects of the present subject matter are directed to features for reducing light pollution, or to the blocking of light from light sources 324 through front display opening 132. Specifically, as illustrated, lighting system 300 may be positioned only within the enclosed back portion 130 of liner 120 such that only the first grow chamber 210 and second grow chamber 212 are exposed to light from light sources 324. Specifically, grow module 200 acts as a physical partition between light assemblies 300 and front display opening 132. In this manner, as illustrated in FIG. 5, no light may pass from first chamber 212 or second chamber 214 through grow module 200 and out through front display opening 132. As grow module 200 rotates, two of the three support sections 220-224 will receive light from lighting system 300 at a time. According still other embodiments, a single light assembly may be used to reduce costs, whereby only a single grow chamber 210 will be lit at a single time.

As illustrated, each lighting assembly includes a plurality of elongated lighting boards, identified generally by reference numeral 310. As shown, the lighting boards are stacked adjacent each other and extend substantially along the axial direction A or the vertical direction V. Specifically, each lighting board 310 may be mounted directly to liner 120 that defines each respective grow chamber 212, 214. The elongated lighting boards 210 may extend parallel to each other and may be spaced apart from each other along the circumferential direction C. Notably, according to the illustrated embodiment, the spacing between elongated boards 210 may be selected such that lighting boards 310 are evenly spaced and cover an entire semicircular arc length of first grow chamber 212 and second grow chamber 214.

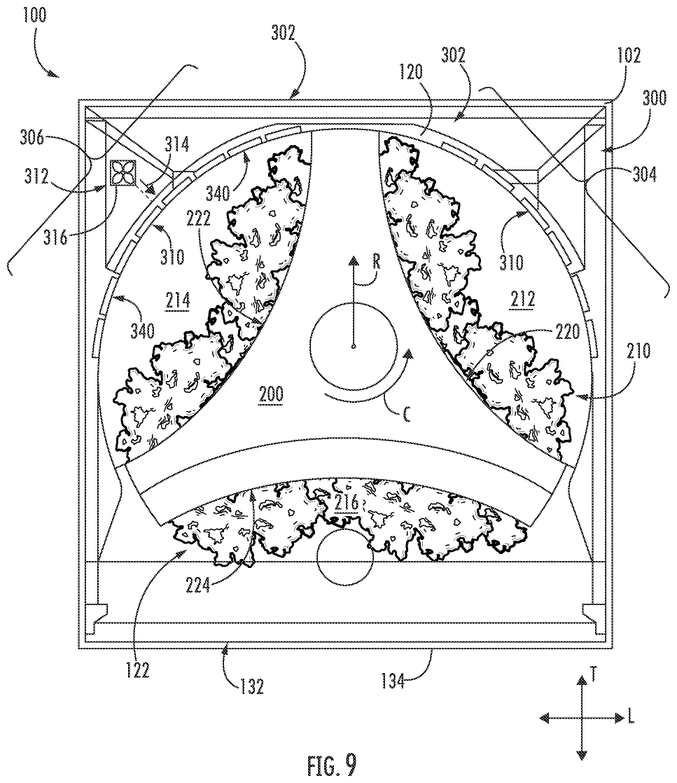

Moreover, as best illustrated in FIG. 9, elongated lighting boards 310 may be mounted to liner 320 such that they are oriented in a normal or perpendicular orientation relative to a surface of insulated liner 120. In this manner, the primary focus of light points inward along the radial direction R, e.g., directly toward grow module 200. In this manner, light generated by lighting assemblies 302 may be better directed toward plants 124 for a more distributed lighting configuration with better light dispersion and coverage.

Notably, lighting assemblies 302 may generate a considerable amount of heat during operation. As a result, it may be desirable that gardening appliance 100 include systems for cooling lighting system 300. Thus, referring still to FIG. 9, gardening appliance 100 may include a fan assembly 312 that is generally configured for directing a flow of cooling air (e.g., identified generally by reference numeral 314) over lighting assemblies 302 in order to maintain a suitably low operating temperature. In this regard, fan assembly 312 may include any suitable fan (e.g., such as axial fan 316), air blower, air handler, or other device for urging a flow of air 314 over or near lighting assembly 302.

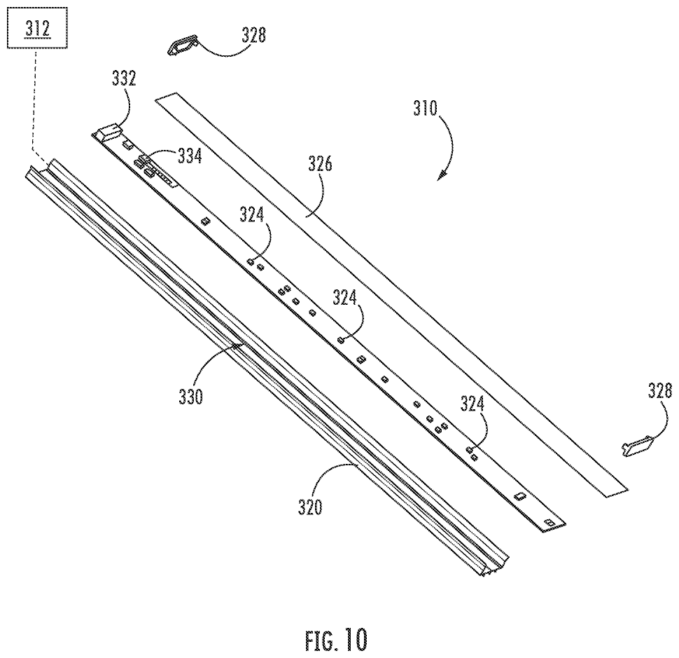

Referring now to FIG. 10, an exemplary elongated lighting board 310 will be described according to an exemplary embodiment of the present subject matter. As shown, each light board 310 may include a support housing 320 that is designed for receiving a printed circuit board 322 on which one or more light sources 324 may be mounted. In addition, a transparent cover 326 may be positioned over or enclose housing 320, and endcaps or seals 328 may be positioned on a top and bottom end of the support housing 320. In this manner, support housing 320, cover 326, and seals 328 may define a substantially enclosed and environmentally isolated compartment or plenum 330 for receiving printed circuit board 322 and light sources 324.

Notably, elongated lighting board 310 may further include features for facilitating cooling, e.g., such as by being fluidly coupled to a fan assembly 312 described above. In this regard, plenum 330 may be fluidly coupled to a fan assembly 312 for receiving a flow of cooling air 314 which may pass over printed circuit board 322 and/or light sources 324 in order to cool light sources 324. It should be appreciated that support housing 320 and/or printed circuit board 322 may further include additional heat sinks or heat dissipating fins for facilitating improved heat transfer.

According to the illustrated embodiment, each printed circuit board 322 may include a dedicated power supply 332 and/or control electronics (e.g., identified generally by reference numeral 334) for independently regulating the operation of each light source 324. In addition, controller 174 may be operatively coupled to each elongated lighting board 310 and lighting assembly 302 for independently regulating operation, e.g., depending on any suitable factors such as plant needs, user commands, etc. In addition, controller 174 may be configured for syncing or coordinating the rotation of grow module 200 into the various grow chambers 212-216 such that each plant 124 receive the optimal amount and time of lighting and environmental requirements that can be provided in each grow chamber 212-216. For example, grow module 200 may be rotated between about every 2 hours and 24 hours, between about every 4 hours and 12 hours, or about every 8 hours. Thus, according to an exemplary embodiment, each support section 220-224 may circulate through all three sub chambers 210 in a single 24-hour period. It should be appreciated that the lighting, temperature, hydration, and other environmental factors within the chambers may be independently regulated in each grow chamber 212-216 in any suitable manner while remaining within the scope the present subject matter.

As best shown in FIG. 10, each elongated lighting board 310 may include a plurality of light sources 324 stacked in an array, e.g., extending along the vertical direction V. For example, light sources 324 may be mounted directly to printed circuit board 322 which may be positioned in front of or behind liner 120 such that light may be transmitted directly through cover 326 into grow chambers 212-214. Exemplary light types and methods of operation are described herein. However, it should be appreciated that the position, configuration, and type of light sources 324 described herein are not intended to limit the scope of the present subject matter in any manner.

Light sources 324 may be provided as any suitable number, type, position, and configuration of electrical light source(s), using any suitable light technology and illuminating in any suitable color. For example, according to the illustrated embodiment, light source 324 includes one or more light emitting diodes (LEDs), which may each illuminate in a single color (e.g., white LEDs), or which may each illuminate in multiple colors (e.g., multi-color or RGB LEDs) depending on the control signal from controller 174. For example, according to an exemplary embodiment, first lighting assembly 304 and second lighting assembly 306 may include at least one of a white light emitting diode or a red light emitting diode. However, it should be appreciated that according to alternative embodiments, light sources 324 may include any other suitable traditional light bulbs or sources, such as halogen bulbs, fluorescent bulbs, incandescent bulbs, glow bars, a fiber light source, etc.

According to exemplary embodiments of the present subject matter, lighting system may use ultraviolet lights to improve the health, robustness, or overall quality of plants 124 in gardening appliance 100. Specifically, according to the illustrated embodiment, second lighting assembly 306 may include ultraviolet (UV) lighting boards 340 that include ultraviolet lights. Notably, these UV lighting boards 340 may be the same or similar to elongated lighting boards 310, except that at least one of the light sources 324 mounted thereon is an ultraviolet light. According still other embodiments, UV lighting boards 340 may generate ultraviolet light in the A- or B-spectrum. In this regard, controller 174 may be configured for selectively generating UVA light, UVB light, or some combination there between. In general, UVA and UVB light may be used to supplement standard grow lighting and improve the robustness of plants 124 upon harvesting.

It should be appreciated that controller 174 may adjust any suitable operating parameters of lighting system 300 as needed to facilitate improved plant growth, photosynthesis, robustness, etc. In this regard, for example, controller 174 may independently regulate each lighting board 310, 340, and may even independently regulate each light source 324 on those respective lighting boards 310, 340, to generate any suitable light having any suitable wavelength, intensity, color, or other lighting profile variations. In this manner, lighting system 300 provides a versatile system for generating the desired types and quantities of light for optimal plant growth.

Gardening appliance 100 and grow module 200 have been described above to explain an exemplary embodiment of the present subject matter. However, it should be appreciated that variations and modifications may be made while remaining within the scope of the present subject matter. For example, according to alternative embodiments, gardening appliance 100 may be a simplified to a two-chamber embodiment with a square liner 120 and a grow module 200 having two partitions 206 extending from opposite sides of central hub 202 to define a first support section and a second support section. According to such an embodiment, by rotating grow module 200 by 180 degrees about central axis 206, the first support section may alternate between the sealed position (e.g., facing rear side 114 of cabinet 102) and the display position (e.g., facing front side 112 of cabinet 102). By contrast, the same rotation will move the second support section from the display position to the sealed position. According to still other embodiments, gardening appliance 100 may include a three chamber grow module 200 but may have a modified cabinet 102 such that front display opening 132 is wider and two of the three grow chambers 210 are displayed at a single time. Thus, first chamber 212 may be in the sealed position, while second chamber 214 and third chamber 216 may be in the display positions.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims. cm What is claimed is:

1. A gardening appliance, comprising:
a liner positioned within a cabinet and defining a grow chamber;
a grow module rotatably mounted within the liner, the grow module dividing the grow chamber into a plurality of grow chambers;
a first lighting assembly positioned within the liner adjacent a first grow chamber of the plurality of grow chambers;
a second lighting assembly positioned within the liner adjacent a second grow chamber of the plurality of grow chambers; and
a controller operably coupled to the first lighting assembly and the second lighting assembly, the controller being configured to operate each of the first lighting assembly and the second lighting assembly independently based on needs of plants located within the first grow chamber and the second grow chamber.

2. The gardening appliance of claim 1, wherein each of the first lighting assembly and the second lighting assembly comprises one or more elongated lighting boards that extend along an axial direction.

3. The gardening appliance of claim 2, wherein the one or more elongated lighting boards are spaced apart along a circumferential direction along substantially an entire arc length of the liner.

4. The gardening appliance of claim 1, wherein at least one of the first lighting assembly or the second lighting assembly comprises one or more ultraviolet lights.

5. The gardening appliance of claim 4, wherein the one or more ultraviolet lights generate ultraviolet-A and ultraviolet-B light.

6. The gardening appliance of claim 5, wherein the controller is configured to independently regulate the ultraviolet-A and the ultraviolet-B light.

7. The gardening appliance of claim 1, wherein the first lighting assembly and the second lighting assembly comprises at least one of a white light emitting diode or a red light emitting diode.

8. The gardening appliance of claim 1, wherein the controller is configured to independently regulate a wavelength and an intensity of the first lighting assembly and the second lighting assembly.

9. The gardening appliance of claim 1, wherein the liner defines a front display opening, and wherein the grow module blocks view of the first grow chamber and the second grow chamber from the front display opening.

10. The gardening appliance of claim 1, wherein the liner is curved around the grow module, and wherein the first lighting assembly and the second lighting assembly are mounted to the liner and are oriented such that light is directed normal to the liner.

11. The gardening appliance of claim 1, wherein the grow module divides the grow chamber into three grow chambers, each of the three grow chamber spanning 120 degrees of the grow chamber in a circumferential direction.

12. The gardening appliance of claim 1, wherein the controller is configured to rotate the grow module between about every four to twelve hours.

13. The gardening appliance of claim 1, further comprising:
a fan assembly for directing a flow of cooling air over the first lighting assembly and the second lighting assembly.

14. A lighting system for a gardening appliance, the gardening appliance comprising a liner positioned defining a grow chamber and a grow module rotatably mounted within the liner and dividing the grow chamber into a first grow chamber and a second grow chamber, the lighting system comprising:
a first lighting assembly positioned within the liner adjacent the first grow chamber;
a second lighting assembly positioned within the liner adjacent the second grow chamber; and
a controller operably coupled to the first lighting assembly and the second lighting assembly, the controller being configured to operate each of the first lighting assembly and the second lighting assembly independently based on needs of plants located within the first grow chamber and the second grow chamber.

15. The lighting system of claim 14, wherein each of the first lighting assembly and the second lighting assembly comprises one or more elongated lighting boards that extend along an axial direction and are spaced apart along a circumferential direction along substantially an entire arc length of the liner.

16. The lighting system of claim 14, wherein at least one of the first lighting assembly or the second lighting assembly comprises one or more ultraviolet lights.

17. The lighting system of claim 15, wherein the one or more ultraviolet lights generate ultraviolet-A and ultraviolet-B light and may be independently regulated.

18. The lighting system of claim 14, wherein the first lighting assembly and the second lighting assembly comprises at least one of a white light emitting diode or a red light emitting diode.

19. The lighting system of claim 14, wherein the controller is configured to independently regulate a wavelength and an intensity of the first lighting assembly and the second lighting assembly.

20. The lighting system of claim 14, wherein the liner is curved around the grow module, and wherein the first lighting assembly and the second lighting assembly are mounted to the liner and are oriented such that light is directed normal to the liner.
